(19) United States
(12) Patent Application Publication
(10) Pub. No.: US 2022/0148428 A1
(43) Pub. Date: May 12, 2022

(54) HIGH INNOVATION DISTRIBUTED SYSTEM FOR THE MANAGEMENT OF DEMARCATED AREAS

(71) Applicant: PARK SMART, S.R.L., Catania (IT)

(72) Inventors: Giuseppe PATANE, Catania (IT); Carlo Alberto SCIUTO, Gravina di Catania (IT); Pierluigi BUTTIGLIERI, Catania (IT); Marco SCIUTO, Gravina di Catania (IT); Sebastiano BATTIATO, Acicatena (IT)

(73) Assignee: PARK SMART, S.R.L., Catania (IT)

(21) Appl. No.: 17/265,629

(22) PCT Filed: Jul. 26, 2019
(86) PCT No.: PCT/IB2019/056394

§ 371 Date: Feb. 3, 2021

(30) Foreign Application Priority Data
Feb. 8, 2018 (IT) 102018000007632

(51) Int. Cl. G08G 1/14; G07B 15/06

(52) U.S. Cl. CPC G08G 1/146; G07B 15/063; G08G 1/141

(57) ABSTRACT

This invention concerns a system and a method for the management of delimited areas distributed on a territory. A predisposition of a plurality devices distributed on the territory is provided, each one capable of monitoring a predetermined area, each distributed device being of an “embedded” type and includes: a local “embedded” processor connected to at least one video camera positioned nearby and from which it acquires the images that it processes according to a “deep learning” module and “Computer Vision” technique. The deep learning model is based on a CNN (computer neural network) for the detection of vehicles occupying spaces and the identification of areas that can be occupied, both in delimited areas with a defined layout and in areas with an undefined layout, the data processed being sent to a central unit via an Internet network in one example.

### SCOPE OF THE INVENTION

The object of this invention is a highly innovative distributed system for the management of statically and/or dynamically delimited areas.

### BRIEF COMMENTS ON PRIOR ART

As is known, up until today it has been somewhat difficult to efficiently manage delimited areas like roadways, squares, ports, delimited areas in the sea, lagoons, lakes and rivers, in that there are often few reserved spaces and their availability is variable, in various moments of the day and during different periods of the year.

For this reason, recently, a need was perceived for a detection system for detection of available parking spaces (for any type of vehicle or boat) in delimited areas. In the literature there are systems for the management of parking (CN105554878A, CN206179229U, US20050280555A1).

Some systems use sensors to signal the presence of a vehicle in parking stall usually positioned in the parking stall and that detect, in this way, the presence of a vehicle positioned in the stall immediately above the zone where the sensor is installed. Other systems instead provide sensors installed underground.

However, these systems are not capable of foreseeing which parking space is free before it is actually occupied by a vehicle. Moreover, the underground sensors are not capable of identifying the vehicles precisely.

There are also known ultrasonic sensor systems installed in the roof of a parking garage in correspondence to the parking areas where vehicles are parked.

However, the current state-of-the-art offers no systems capable of the automatic on-site management and elaboration of heterogeneous stalls (also virtual, in absence of a specific layout) distributed throughout the territory, using simple systems that are at the same time efficient and functional.

To this view, for example, the publication CN107967817 is known.

### SUMMARY OF THE INVENTION

It is therefore the scope of this invention to provide a system, and relative method, that makes it possible to overcome the technical inconveniences described above.

More specifically, it is the scope of this invention to provide a system that makes it possible to precisely determine if a stall is free or not, allowing the management of multiple areas, even if they are separated by a substantial distance, with extreme precision that can be actuated at a low cost.

These and other scopes are achieved with a system as claimed.

More specifically, here is a description of a highly innovative distributed system for the management of delimited areas characterized by:

Distributed system of processors with video cameras and sensors equipped with Internet connectivity by means of a WIFI NETWORK or Internet Gateway;

Each processor distributed is equipped with a “deep” module for the analysis of the multimedia streaming acquired;

Each processor distributed is equipped with a module for the “parking blockchain”, for the purpose of recording and sharing the area-vehicle transactions of in the delimited area in question;

Connectivity interface for accessing said system via Internet or WIFI;

Calculator capable of carrying out the analysis of the data acquired by the distributed system and the reliability of the blockchain, by means of the expert system;

Deep-learning model based on the CNN network for detecting parked vehicles and determining the occupiable areas (for parking), both in delimited areas with a definitive layout (ex. parking stalls marked with lines) and in areas with an undefined layout (ex. virtual stalls);

HMI interface to return feedback on the current situation detected during a specific temporal range;

HMI interface to suggest a potential area-vehicle transaction or an occupiable space in function of the type of vehicle in question;

Module to carry out the register of the blockchain considering all the area-vehicle transactions of the “parking blockchain”, that is the tuples characterized by the blockchain_node, timestamp, transaction_area and detected_dimension.

Advantageously, the processor can use the potential of the Computer Vision that enables the optimization of the analysis to be carried out.

The potential improves when these are in combination with “blockchain oriented” systems.

Advantageously, said system is capable of determining a transaction in the “parking blockchain” if the time of said association is longer than the threshold of the S_ERROR system and determining an “unlocking” transaction of the transaction_area if the detected_dimension is 0;

Advantageously, said system is capable of providing the GPS coordinates of potential area/vehicle transactions (transaction_area) of the occupiable area and assist the user in the parking facility, so that the transaction is effectively optimized according to the availability of the area and the vehicle in question;

Advantageously, all the data is logged and managed in time, generating data analysis reports for ongoing improvement. These aspects can be used by bodies dealing in the control and for contractual purposes, thereby providing an objective overview of the management and organization of parking activities.

Advantageously, the central processor determines the IPB index, the reliability index of the parking blockchain, characterized by the number of transactions carried out (Tx) and transactions failed (Tf) compared to a suggested number of transactions (Ts), taking into account environmental factors (A) and the operator-user feedback (F), which has been appropriately weighed (p).

Advantageously, the application can be used on delimited road area or in non-road areas (ex. ports, sea, lagoons, lakes, etc.), and more specifically for the boat landings, with particular reference to maritime slips.

Advantageously, said system can detect queues at toll booths differentiated by lane, thanks to one or more video cameras connected to the individual distributed processor, suggesting which lane to prefer and/or generating relative alarms.

Advantageously, the fee policy of the individual parking stall can be time-variant and space-variant (for autos and/or boats) according to the algorithm shared between the processors.

Advantageously, the system is capable of detecting the presence of persons and/or vehicles and activating actuators to activate, deactivate, and regulate the lighting system of the delimited area.

### BRIEF DESCRIPTION OF THE DRAWINGS

Further characteristics and advantages of this system and relative method, according to the invention, will be clarified with the description that follows of some of its embodiments, made by way of examples which are non-limiting, with reference to the attached drawings, where:

FIG. 1 illustrates a block diagram of the invention;

FIG. 2 and FIG. 3 illustrate an example of functioning in which the video camera acquires an image relative to a free area and an area occupied by a vehicle;

FIG. 4 illustrates the sending of the results, once the data acquired has been processed, continually to a central server that makes them usable to an operator;

FIG. 5 is another overview.

### DESCRIPTION OF SOME OF THE PREFERRED EMBODIMENTS

In the context above, the scope of the invention is essentially to provide a highly innovative system for the management of delimited areas, either with a defined layout or free layout, characterized by a distributed system of embedded systems (1) equipped with video cameras and sensors (2), equipped with a “deep” analysis module (3), a module for implementing the “parking blockchain” node (7) and equipped with Internet connectivity by means of a WIFI NETWORK or Internet Gateway (4).

This connection system makes it possible to carry out the dialog with other nodes of the “parking blockchain” and with a central processing unit capable of carrying out analysis of the data managed by the “parking blockchain” via an expert system.

Advantageously, according to the invention, the system exploits the physical infrastructure of surveillance video cameras, also those already present on the territory, connecting them to the distributed systems of the “parking blockchain”.

By way of example, in a parking facility, multiple distributed devices will be installed, capable of monitoring multiple areas by means of “Computer Vision”, and distributing the information on the status of the area in question and relative vehicle-space associations. The integrated use of video cameras and sensors hence makes it possible to improve the reliability of the control of the area. The information distributed between the various nodes of the blockchain makes it possible to have a faithful overview of all the parking areas managed.

By transmitting the values detected also to a data processing unit (5), it is possible to identify bugs in the process or potential issues with the blockchain nodes, and also carry out forecasts thanks to the expert system present in the central processor. The data processing unit is intended as a standard calculator or a server where the database and expert system for the control of the blockchain are contained.

Indeed, this calculator analyses the transactions managed by the distributed systems, evaluates their performances and recognizes critical situations automatically.

To carry out the on-board analysis of the distributed systems, a “deep learning” model is set up, capable of learning and self-learning the vehicle-space associations, also in consideration of the relative dimensions occupied, so as to carry out a monitoring that is faithful to the delimited area, whether with a defined or undefined layout. Indeed, the system is capable of both managing the delimited area with a predefined layout (ex. Stripes, moorings on piers) as well as those without a predefined layout (ex. street area without the separation of individual parking spaces) by using information like the dimensions of the free parking space and those of the potential occupying vehicle.

The “deep” model is present on the individual device distributed and is based on a standard network (CNN—Convolutional Neural Network) trained on a specific training set of vehicles for specific delimited areas.

The vehicle-space association determines a transaction in the “parking blockchain” if the time of this association exceeds the S_ERROR system threshold.

A transaction of the “parking blockchain” is a tuple characterized by (blockchain_node, timestamp, transaction_area, detected_dimension). If the detected_dimension is 0 there will be an “unlocking” transaction of the transaction_area.

This tuple therefore makes it possible to monitor all the transaction_areas monitored among all the blockchain nodes in real time, for the purpose of quickly suggesting that the user park in adjacent areas. This system can also be used to monitor port areas and delimited areas in the sea, lakes, lagoons and rivers.

The HMI interface (6) is used by the system user for process control, making it possible to visualize the system notifications and criticalities. The HMI interface used by the user involved in the parking facility can suggest a new parking space in real time (potential area-vehicle blockchain transaction) based on the transaction register exchanged by the blockchain nodes. The system takes into account the dimensions of the vehicle involved in occupying a free stall, of the distances between parking stalls, applicable speed, and traveling time between stalls. The system signals the user a physical or virtual stall (in case of an undefined layout) providing the relative GPS coordinates and assisting him in parking, so that the transaction is effectively optimized.

Moreover, everything is logged by the central system and managed over time, generating data analysis reports and relative corporate risk trends detected. This information can be used by control authorities for management problems to provide an objective overview of such management. This information can also be used for organization of the delimited areas. To this view, a reliability index of the “parking blockchain”, like IPB, is used, characterized by the number of transactions carried out (Tx) and transactions failed (Tf) compared to a suggested number of transactions (Ts), taking into account environmental factors (A) and the operator-user feedback (F), which has been appropriately weighed (p).

$$IPB = \frac{{Σ}_{1}^{n} {Tx}_{i} - {Σ}_{1}^{m} {Tf}_{i} + A}{{Σ}_{1}^{l} {Ts}_{i}} + \frac{{Σ}_{1}^{t} {F}_{i}}{t} p$$

Maximizing the IPB is the objective of the system manager.

Moreover, the system is capable of determining the cost of parking as a function of the time of day (considering also the log series and events) and the availability of existing spaces.

Furthermore, the system, given its flexibility in managing heterogeneous areas, can also be adapted for the real-time management (integrated lane by lane) of the queues at motorway toll booths, evaluating the flow of vehicles by individual lanes in order to monitor potential bottlenecks, suggest the lane to users, and generate alarms where problems are detected by the system.

Moreover, through the use of “Computer Vision”, the system is capable of detecting the luminance of the scene and activating actuators to dim or increase the intensity of a lighting system in such a way as to guarantee people and/or vehicles correct visibility.

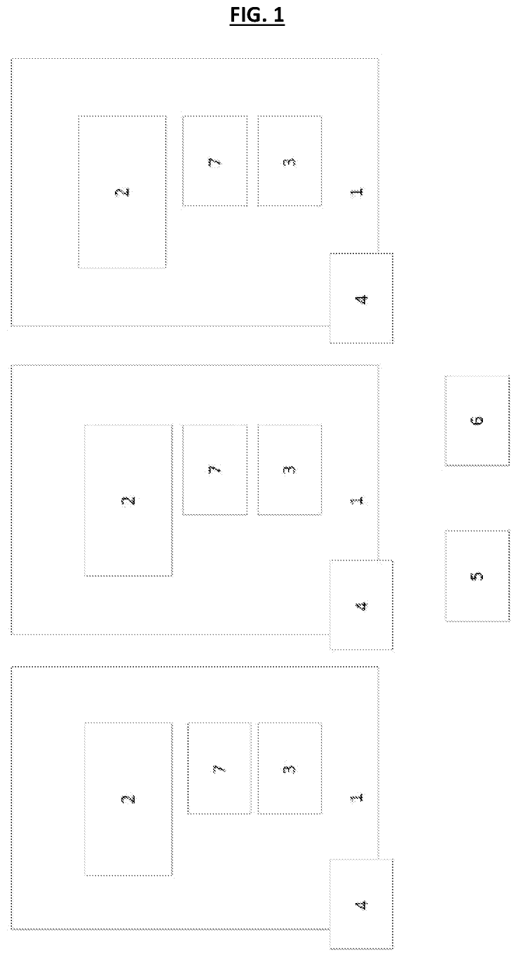

An exemplary graphic representation of this system is provided in FIG. 1.

More in detail, with reference to FIG. 1, the block diagram is described that illustrates the components introduced above.

In particular, each group 1 is dislocated in a predetermined area to be monitored and each group can be very distant from the remaining ones.

Each group 1 includes the processor, which is generally positioned in proximity to the video camera. The video camera is preferably fixed to a support pole or another support and the processor, set up in a special box or in a specific road cabinet, is positioned at the feet of the video camera or at a certain distance and communicates with it via wireless or via cable, but not with an Internet connection, seeing the relatively short distance between them.

Ethernet electrical cables can be used with a length of up to 100 (m) from the street cabinet to the pole without adding signal repeater switches.

Alternatively, wiring can be done in fibre optics, even if the installation costs are higher.

This type of processor is an “embedded” type and falls under the category of the IoT (Internet of Things) in that it contains all the hardware and software components necessary to carry out specific tasks and is capable of processing large quantities of data locally (ex: images and/or videos in streaming) without needing to transmit them via Internet or a server to subsequently process them. Hence, everything is processed “in loco”.

Then the information extracted by the processing done locally on the “embedded” processor is sent via the Internet. Essentially, the video camera communicates with its processor without Internet communication but via cable or wireless, in that they are positioned nearby and everything is elaborated in loco for each group 1.

Each group 1 therefore contains the “deep learning” modules and the “Computer Vision” module belonging to the processor that uses them to analyze the images and give a result.

The result is sent to the central server 5, which preferably works in the “cloud” and can be reached via the Internet network.

In this way, any user, for example through an App and a mobile device, can access the data to verify if the parking space is free or not.

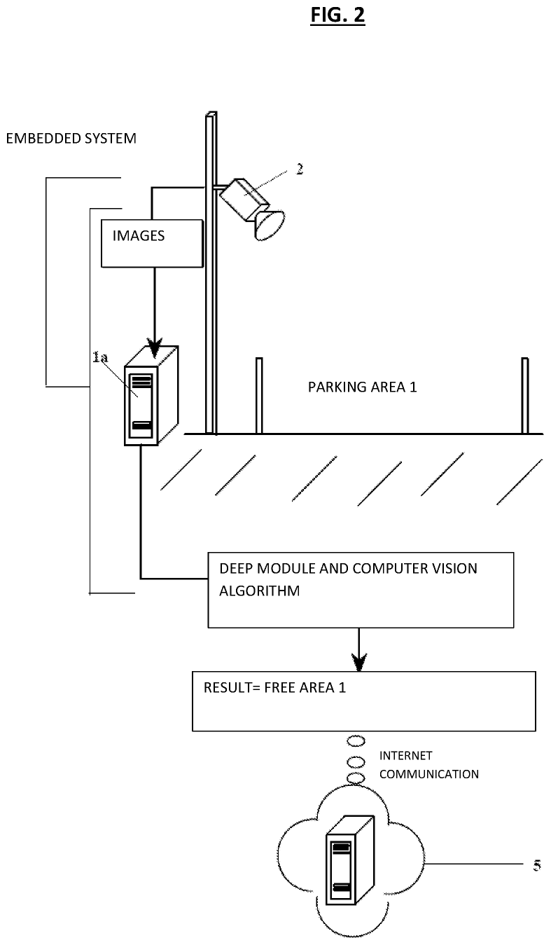

FIG. 2, therefore, presents for example a video camera positioned in such a way as to record a dedicated parking area. The video camera may also be an existing one and is connected to the box containing the processor (1a). The images are continuously analyzed by the deep module and the above mentioned “Computer Vision” algorithms for the purpose of extrapolating a result corresponding to a free or occupied space.

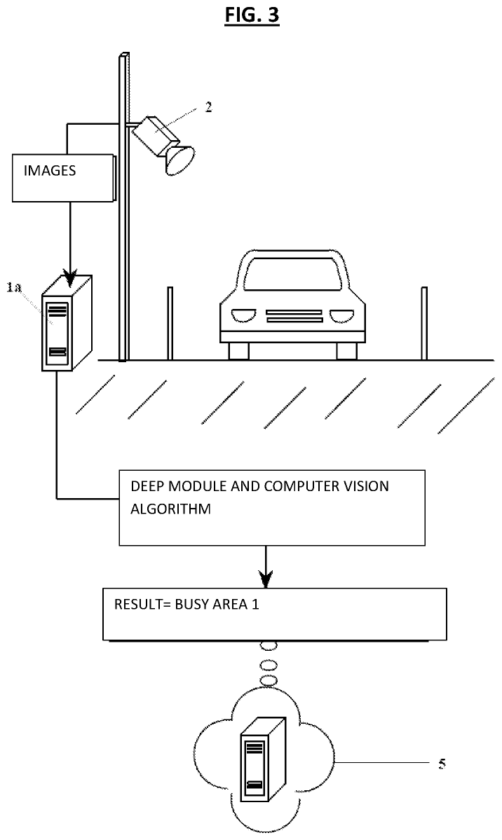

The example in FIG. 2 illustrates a free space, while the example in FIG. 3 illustrates the case of an occupied space.

The images are recorded continuously and therefore are also analyzed, recognizing the presence or absence of the vehicle.

The “deep learning” programming, together with the Computer Vision algorithms, makes it possible to obtain excellent results in terms of precision that would otherwise be impossible to obtain, in that it enables the determination of the presence of vehicles with certainty, avoiding the exchange of foreign objects (for example, even passers-by standing in the stall being analyzed) as well as parked vehicles.

Artificial intelligence techniques like “deep learning” and “Computer Vision” techniques are well-known, and for this reason are not described in further detail herein.

The processor will then have a further algorithm to determine if the space is free or occupied, updating itself in real time. If for example, a parked car leaves, the successive images processed according to the above-mentioned models, will indicate the absence of the vehicle. If this repeats itself for a succession of frames—for example—5 sec, then the software interprets this information as the passing from an occupied status to a free status.

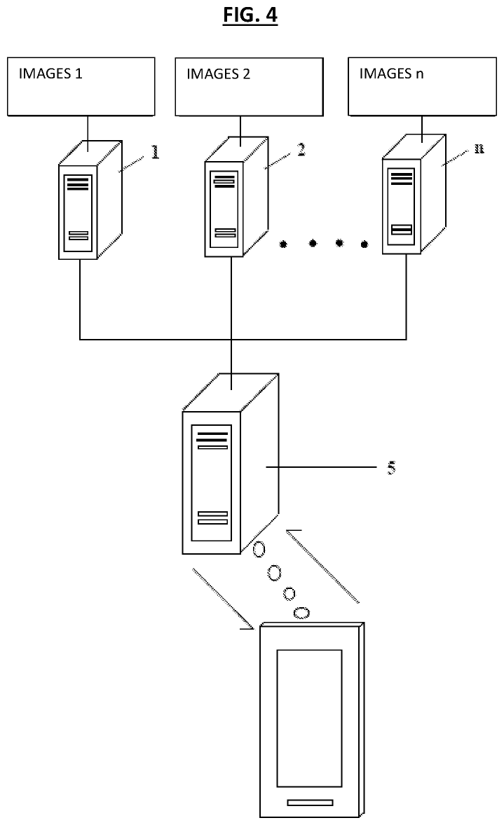

The above-mentioned data, which is updated in a continuous cycle, is then sent to a central server 5, outlined in FIG. 4, which is accessible by any user in order to verify the availability of spaces in the immediate area and time.

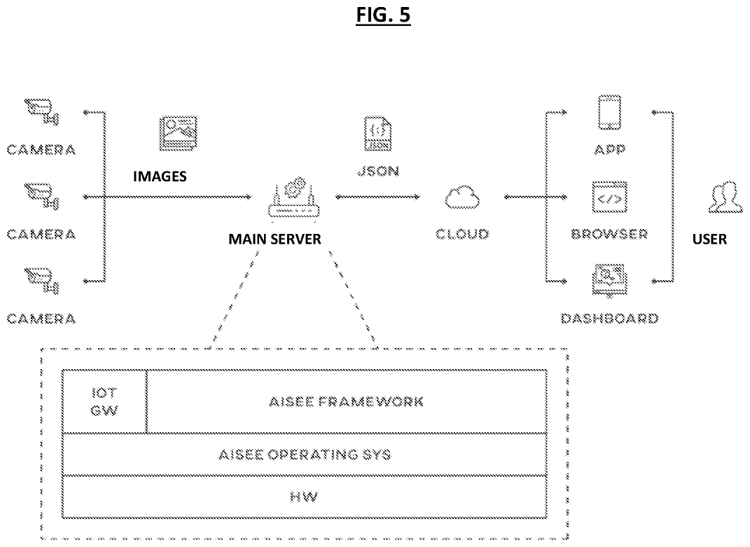

FIG. 5 outlines the overall stream in which “local” video cameras 2 acquire an image that is then processed by the relative local processors, each of which is associated a single or a group of specific video cameras. The results, that may then correspond to various parking areas dislocated at a substantial distance from each other, are sent to the central server using the JSON format, which makes the results available to the user, preferably on a cloud system. The information is then sent to the users' and parking controllers' apps, to the administrative dashboards and to the information dashboards for public administrations.

FIG. 5 then illustrates the various methods known with which the user can access the info, for example, by use of mobile Apps, browsers, PCs etc.

In this invention, the term “Deep Learning” refers to algorithms and the technologies that are well-known to the state-of-the-art and technically can be traced to the family of Artificial Intelligence techniques. These algorithms are characterized by the presence of a level graph, called layers, in which each individual level consists of elements that apply mathematical functions to an input, determining a result.

More specifically, the engineering of the elements and the levels is inspired by models of functioning of the human brain, from which the name neural network derives. The neural network develops in height, from the level at which the input is supplied (upper) to the level that produces the result (lower). When the number of levels is substantial, “Deep Neural Network” result. Precisely like a human brain is a tabula rasa at birth, a neural network has no capacity at the time of its initialization; it becomes capable of resolving problems only after a learning phase.

The term “Computer Vision” is also well known.

More specifically, Computer Vision is a branch of science that aims to recreate the mechanisms of human sight in computational form, and therefore in such a way that these mechanisms can be carried out by a calculator. This discipline ranges from reconstruction in 3D—or the comprehension and reconstruction of spatial and volumetric aspects of a scene—beginning with two-dimensional images acquired digitally, to the semantic comprehension of the scene, where the content of the image is analyzed for the purpose of providing a description of the elements comprised therein, both on a punctual level (or a level of pixels) and on a macroscopic level (groups of pixels that form objects). Among the problems dealt with by Computer Vision there are also the classification of images into macro-categories and the identification of objects within the image itself.

The term “Embedded System” is well-known; in other words, in computer science and digital electronics, this term is used to generically identify all electronic processing systems with microprocessors custom engineered for a specific use, or in other words, that cannot be reprogrammed by the user for other purposes, often with an ad hoc platform, integrated into the system that they control and are capable of managing all or part of the functions required.

More specifically, the “embedded” processor used in this invention was conceived, engineered and constructed to be capable of supporting other specific technologies for “smart cities”, each of these embedded processors represents nodes of the distributed infrastructure, the management, maintenance and administration of which is centralized through a platform in the cloud that coordinates them.

This embedded processor is the ideal system to make the city Smart.

1. A system for management of delimited areas distributed on a territory, said system comprising a plurality of distributed devices on the territory, each distributed device is capable of monitoring a predetermined area;
characterized by the fact that each distributed device is an “embedded” type and comprises:
A local “embedded” processor equipped with Internet connectivity by means of a WIFI NETWORK or Internet Gateway, each local processor being equipped with a “deep learning” module capable of learning and self-learning vehicle-space associations for analysis of multimedia streams via a “Computer Vision” technique, each local processor being connected to at least one video camera from which the local processor acquires images to process according to said “deep learning” module and “Computer Vision” technique, the deep learning model being based on a CNN (computer neural network) for detecting occupying vehicles and identifying occupiable areas, both in delimited areas with a defined layout and in areas with an undefined layout;
Each local processor being equipped with a module for a “parking blockchain”, for the purpose of recording and sharing area-vehicle transactions carried out in a corresponding delimited area;
Each local processor also being equipped with a connectivity interface, for the purpose of accessing said system by means of Internet or WIFI, and a calculator capable of carrying out analysis of data acquired by the system and reliability of the parking blockchain;
Said system also comprising a first HMI interface (human machine interface) to return feedback on status detected during a specific temporal range;
Said system comprising a second HMI interface to suggest a potential area-vehicle transaction or an occupiable space in function of the type of vehicle in question;
Said system comprising a module to carry out the register of the blockchain considering all the area-vehicle transactions of the “parking blockchain”, that is the tuples characterized by the blockchain_node, timestamp, transaction_area and detected_dimension.

2. The system, according to claim 1, in which a further data storage unit is included to which each local processor transmits the data once it has been processed.

3. The system, according to claim 2, in which said data processed locally in the specific local processor is sent via WIFI NETWORK or Internet Gateway.

4. The system, according to claim 1, in which the communications between the video camera and the relative local “embedded” processor does not occur via the Internet.

5. The system, according to claim 1, in which the video camera is positioned in proximity to the processor and communicating with each other via cable or via wireless connection, without an Internet network.

6. A method for management of delimited areas distributed on a territory, said method providing a predisposition of a plurality devices distributed on a territory, each distributed device capable of monitoring a predetermined area, each distributed device being of an “embedded” type and comprising:
A local “embedded” processor connected to at least one video camera positioned nearby and from which the distributed device acquires images that it processes according to a “deep learning” module capable of learning and self-learning the vehicle-space associations for the analysis of multimedia streams and “Computer Vision” technique, the deep learning model being based on the CNN (computer neural network) for the detection of occupying vehicles and the identification of occupiable areas, both in delimited areas with a defined layout and in areas with an undefined layout, the data processed being sent to a central unit via Internet network accessible to an external user, the communication between the video camera and the associated processor not taking place via Internet network.

7. The method, according to claim 6, wherein each local processor is equipped with a module for the “parking blockchain”, which records and shares the area-vehicle transactions that took place in the delimited area, and in which the analysis of the data acquired by the distributed system and the reliability of the blockchain is conducted.

8. The method, according to claim 6, wherein through an HMI interface feedback on status is returned and a temporal range is detected and a potential area-vehicle transaction is suggested, that is an occupiable space in function of the type of vehicle in question.

9. The method, according to claim 7, wherein a transaction in the “parking blockchain” is determined if the time of said vehicle-space association is longer than a threshold of an S_ERROR system and determining an “unlocking” transaction of the transaction_area if the detected_dimension is 0.

10. A method, according to claim 6, wherein the relative GPS coordinates (transaction_area) of the occupiable area for potential area-vehicle transactions are provided and assistance is given to the user in the parking facility so that the transaction is optimized in so far as possible according to the availability of the area and of the vehicle in question.

11. A method, according to claim 6, in which all the data is logged and managed over time, generating data analysis reports for ongoing improvement to provide an objective overview of management and organization of parking activities.

12. A method, according to claim 6, wherein the central processor determines an IPB index, the reliability index of the parking blockchain, characterized by a number of transactions carried out (Tx) and transactions failed (Tf) compared to a suggested number of transactions (Ts), taking into account environmental factors (A) and operator-user feedback (F), which has been appropriately weighed (p).

13. A method, according to claim 6, where the application can take place on delimited road areas or in non-road areas like, for example, ports, sea, lagoons, lakes, boat slips, with particular reference to parking in water.

14. A method, according to claim 6, in which queues are detected at toll booths differentiated by lane based on one or more video cameras connected to the single distributed processor, to suggest a lane and/or to generate relative alarms.
